(19) United States
(12) Patent Application Publication
(10) Pub. No.: US 2009/0317573 A1
(43) Pub. Date: Dec. 24, 2009

(54) Oxygen absorbent, oxygen-absoring film and packaging container

(75) Inventor: Shizuo Kitahara, Tokyo (JP)

Correspondence Address: BIRCH STEWART KOLASCH & BIRCH, PO BOX 747, FALLS CHURCH, VA, 22040-0747, US

(73) Assignee: Zeon Corporation, Tokyo (JP)

(21) Appl. No.: 11/921,243

(22) PCT Filed: May 29, 2006
(86) PCT No.: PCT/JP2006/310670

§ 371 Date: Oct. 30, 2008

(30) Foreign Application Priority Data
May 31, 2005 (JP) 2005-158312

(51) Int. Cl. B32B 1/02; C08F 36/04; C08L 9/00

(52) U.S. Cl. 428/35.7; 526/335; 525/232

(57) ABSTRACT

[Problem] To provide an oxygen absorbent and an oxygen-absorbing film that are excellent in oxygen absorption capability and do not generate an unpleasant odor component upon absorbing oxygen, whereby an unpleasant odor is not generated in a packaging container having them used therein, and an unpleasant odor is not diffused outward from the packaging container.

[Means for Dissolution] An oxygen absorbent comprising a cyclized product of a conjugated diene polymer having a vinyl bond content in a conjugated diene monomer unit moiety of 4% by mol or less is provided. An oxygen-absorbing film comprising a cyclized product of a conjugated diene polymer having a vinyl bond content in a conjugated diene monomer unit moiety of 4% by mol or less, as an effective component is also provided. An oxygen-absorbing film further comprising a thermoplastic resin in addition to the oxygen absorbent is also provided. An oxygen-absorbing multi-layer film, comprising the oxygen-absorbing film as an essential constitutional layer, is also provided. A packaging material comprising the oxygen-absorbing multi-layer film is also provided. A packaging container obtained by molding the oxygen-absorbing multi-layer film is also provided.

### TECHNICAL FIELD

The present invention relates to an oxygen absorbent, an oxygen-absorbing film and a packaging container. More specifically, it relates to an oxygen absorbent and an oxygen-absorbing film that are excellent in oxygen absorption capability and do not generate an unpleasant odor component upon absorbing oxygen, whereby an unpleasant odor is not generated in a packaging container comprised of the same, and an unpleasant odor is not diffused outward from the packaging container, and relates to a packaging container obtained by molding the oxygen-absorbing film.

### BACKGROUND ART

Such a multi-layer structure is often used in the fields including food packaging that comprises a thermoplastic resin excellent in packaging property, such as polyolefin and polystyrene, and a gas barrier resin excellent in oxygen impermeability, such as an ethylene/vinyl alcohol copolymer.

However, a packaging container composed of the multi-layer structure cannot sufficiently prevent oxygen from permeating, and therefore, it has been practiced that a heavy metal-based oxygen scavenger, such as cobalt neodecanoate, is incorporated with the layers constituting the packaging container.

The use of the oxygen scavenger enhances the effect of scavenging oxygen, but it has been pointed out that an odor component is newly generated upon scavenging oxygen. There is such a problem in that the odor component is filled in the packaging container to give uncomfortable feeling when the packaging material is opened, and the odor component permeates through the packaging container to leak outside, thereby transferring to other foods that are stored together in a refrigerator or the like.

Attempts to solve the problem of odor components have been reported. Patent Document 1 proposes such a method in that in a gas barrier resin composition comprising a transition metal salt as an oxygen scavenger, a deodorizer, such as a composition of zinc silicate or zinc oxide with alum, is incorporated with a gas barrier resin layer or a thermoplastic resin layer.

Patent Document 2 reports a multi-layer structure that comprises an oxygen-absorbing resin composition comprised of a transition metal catalyst and an oxidizing organic component and provided therewith, as an odor barrier layer, a resin composition comprised of amine-supporting porous silica and a thermoplastic resin such as an ethylene/vinyl alcohol copolymer.

In the multi-layer structures mentioned above, however, various kinds of odor components are generated through reactions of the transition metal salt and the like, and thus the odor components cannot completely scavenged with the odor barrier layer proposed.

Accordingly, a method for attaining simultaneously both absorption of oxygen and scavenging of odor has not yet been found.

It is needless to say that upon constituting various packaging containers by using an oxygen absorbent, it is basically preferred to decrease the number of layers from the standpoint of production process.

Accordingly, such an oxygen absorbent is demanded that is excellent in oxygen absorption capability and does not require an odor barrier layer or an deodorizing layer.

Patent Document 1: JP-A-2001-106920
(U.S. Pat. No. 6,599,598)

Patent Document 2: JP-A-2005-906

### DISCLOSURE OF THE INVENTION

### Problems to be Solved by the Invention

Accordingly, an object of the invention is to provide an oxygen absorbent and an oxygen-absorbing film that are excellent in oxygen absorption capability and do not generate an unpleasant odor component upon absorbing oxygen, whereby an unpleasant odor is not generated in a packaging container comprised of the same, and an unpleasant odor is not diffused outward from the packaging container. Another object of the invention is to provide a packaging material and a packaging container that comprise the oxygen-absorbing film.

### Means for Solving the Problems

The inventor has found that a cyclized product of a conjugated diene polymer has oxygen absorption capability, and has made earnest investigations on a structure of an oxygen absorbent comprising a cyclized product of a conjugated diene polymer as an effective component, a composition comprising the oxygen absorbent, a structure of various containers obtained by using the oxygen absorbent, and the like, for enhancing the characteristics thereof.

For solving the problem of generation of an odor component upon absorbing oxygen, which has been found in the course of the investigations, a countermeasure therefor by forming a gas barrier layer or a deodorizing layer has been found, and separately, development of an oxygen absorbent that does not have the problem of an odor component has also been further investigated.

Consequently, it has been found that the use of a cyclized product of a conjugated diene polymer having a particular structure as an oxygen absorbent attains the objects, and thus the invention has been completed based on the findings.

The invention provides an oxygen absorbent comprising a cyclized product of a conjugated diene polymer having a vinyl bond content in a conjugated diene monomer unit moiety of 4% by mol or less.

It is preferred that the oxygen absorbent of the invention comprises a cyclized product of a conjugated diene polymer having a vinyl bond content in a conjugated diene monomer unit moiety of the conjugated diene polymer of 2% by mol or less.

It is preferred in the oxygen absorbent of the invention that the cyclized product of a conjugated diene polymer has a weight average molecular weight of from 10,000 to 900,000 and an unsaturated bond reduction rate of from 35 to 75%.

The invention also provides an oxygen-absorbing film comprising a cyclized product of a conjugated diene polymer having a vinyl bond content in a conjugated diene monomer unit moiety of 4% by mol or less, as an effective component.

It is preferred that the oxygen-absorbing film of the invention comprises a cyclized product of a conjugated diene polymer having a vinyl bond content in a conjugated diene monomer unit moiety constituting the conjugated diene polymer of 2% by mol or less.

It is preferred that the oxygen-absorbing film further comprises a thermoplastic resin, and the thermoplastic resin is preferably a polyolefin resin.

The invention further provides an oxygen-absorbing multi-layer film comprising the oxygen-absorbing film as an essential constitutional layer.

The invention still further provides a packaging material comprising the oxygen-absorbing multi-layer film.

The invention still further provides a packaging container obtained by molding the oxygen-absorbing multi-layer film.

### ADVANTAGES OF THE INVENTION

The oxygen absorbent and the oxygen-absorbing film comprising the oxygen absorbent as an effective component are excellent in oxygen absorption capability and do not generate an unpleasant odor component upon absorbing oxygen. Accordingly, a packaging material obtained by molding the oxygen-absorbing film of the invention does not generate an unpleasant odor in the packaging container and does not diffuse an unpleasant odor outward from the packaging container.

Accordingly, the packaging container of the invention is useful particularly in the fields including food packaging.

### BEST MODE FOR CARRYING OUT THE INVENTION

The oxygen absorbent of the invention comprises a cyclized product of a conjugated diene polymer having a vinyl bond content in a conjugated diene monomer unit moiety of 4% by mol or less.

Upon polymerization of a conjugated diene having a 1,3-diene structure, each monomer unit has one of three modes, i.e., a cis-1,4-bond, a trans-1,4-bond and a vinyl bond. In the case of a conjugated diene monomer having different substituents on the 2- and 3-positions, such as isoprene, the vinyl bond may have two modes, i.e., a 1,2-bond and a 3,4-bond.

In the invention, the total of the 1,2-bond content and the 3,4-bond content (which is referred to as a vinyl bond content) is necessarily 4% by mol or less. The vinyl bond content is preferably 3% by mol or less, more preferably 2% by mol or less, and further preferably 1% by mol or less.

The cyclized product of a conjugated diene polymer can be obtained by subjecting a conjugated diene polymer that satisfies the aforementioned condition to a cyclization reaction in the presence of an acid catalyst.

The conjugated diene polymer includes a homopolymer of a conjugated diene monomer, a copolymer thereof, and a copolymer of a conjugated diene monomer with a monomer copolymerizable therewith.

The conjugated diene monomer is not particularly limited, and specific examples thereof include 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene, 3-butyl-1,3-octadiene and the like.

These monomers may be used solely or in combination of two or more kinds of them.

Examples of the monomer copolymerizable with the conjugated diene monomer include an aromatic vinyl monomer, such as styrene, o-methylstyrene, p-methylstyrene, m-methylstyrene, 2,4-dimethylstyrene, ethylstyrene, p-t-butylstyrene, α-methylstyrene, α-methyl-p-methylstyrene, o-chlorostyrene, m-chlorostyrene, p-chlorostyrene, p-bromostyrene, 2,4-dibromostyrene and vinylnaphthalene; a linear olefin monomer, such as ethylene, propylene and 1-butene; a cyclic olefin monomer, such as cyclopentene and 2-norbornene; a nonconjugated diene monomer, such as 1,5-hexadiene, 1,6-heptadiene, 1,7-octadiene, dicyclopentadiene and 5-ethylidene-2-norbornene; a (meth)acrylate ester, such as methyl(meth)acrylate and ethyl(meth)acrylate; other (meth)acrylic acid derivatives, such as (meth)acrylonitrile and (meth)acrylamide; and the like.

These monomers may be used solely or in combination of two or more kinds of them.

Specific examples of the homopolymer and the copolymer of the conjugated diene monomer include natural rubber (NR), polyisoprene rubber (IR), polybutadiene rubber (BR), a butadiene/isoprene copolymer rubber (BIR), trans-polyisoprene and the like. Among these, natural rubber, polyisoprene rubber and polybutadiene rubber are preferred, and polyisoprene rubber is more preferred.

Specific examples of the copolymer of the conjugated diene monomer with a monomer copolymerizable therewith include styrene/isoprene rubber (SIR), styrene/butadiene rubber (SBR), isoprene/isobutylene copolymer rubber (IIR), ethylene/propylene/diene copolymer rubber (EPDM) and the like.

Specific examples of the styrene/isoprene rubber include a block copolymer comprising an aromatic vinyl polymer block having a weight average molecular weight of from 1,000 to 500,000 and at least one conjugated diene polymer block.

The content of the conjugated diene monomer unit in the conjugated diene polymer may be appropriately selected within such a range that the advantages of the invention is not impaired, and is generally 40% by mol or more, preferably 60% by mol or more, and further preferably 80% by mol or more. In the case where the content of the conjugated diene monomer unit is too small, there is a possibility that the unsaturated bond reduction rate does not fall within the appropriate range.

The conjugated diene polymer may be polymerized according to an ordinary method. For example, polymerization may be carried out by solution polymerization or emulsion polymerization with the use of a suitable catalyst, such as a Ziegler polymerization catalyst containing titanium or the like as a catalyst component, an alkyllithium polymerization catalyst or a radical polymerization catalyst, and it is preferred to perform solution polymerization with a Ziegler catalyst for obtaining a conjugated diene polymer having a small vinyl bond content. Such a conjugated diene polymer may also be used that is reduced in the content of a vinyl bond such as a 3,4-bond, through a partial hydrogenation reaction.

The acid catalyst used in the cyclization reaction may be known ones. Specific examples thereof include sulfuric acid; an organic sulfonic acid compound, such as fluoromethanesulfonic acid, difluoromethanesulfonic acid, p-toluenesulfonic acid, xylenesulfonic acid, an alkylbenzenesulfonic acid having an alkyl group having from 2 to 18 carbon atoms, and anhydrides and alkyl esters thereof; a Lewis acid, such as boron trifluoride, boron trichloride, tin tetrachloride, titanium tetrachloride, aluminum chloride, diethylaluminum monochloride, ethylaluminum dichloride, aluminum bromide, antimony pentachloride, tungsten hexachloride and iron chloride; and the like. These acid catalysts may be used solely or in combination of two or more kinds of them. Among these, an organic sulfonic acid compound is preferred, and p-toluenesulfonic acid and xylenesulfonic acid are more preferred.

The used amount of the acid catalyst is generally from 0.05 to 10 parts by weight, preferably from 0.1 to 5 parts by weight, and more preferably from 0.3 to 2 parts by weight, per 100 parts by weight of the conjugated diene polymer.

The cyclization reaction is carried out generally in a solution of the conjugated diene polymer in a hydrocarbon solvent.

The hydrocarbon solvent is not particularly limited as far as the cyclization reaction is not impaired. Specific examples thereof include an aromatic hydrocarbon, such as benzene, toluene, xylene and ethylbenzene; an aliphatic hydrocarbon, such as n-pentane, n-hexane, n-heptane and n-octane; an alicyclic hydrocarbon, such as cyclopentane and cyclohexane; and the like. The hydrocarbon solvent preferably has a boiling point of 70° C. or higher.

A solvent used in a polymerization reaction of the conjugated diene polymer may be the same as the solvent used in the cyclization reaction. In this case, the cyclization reaction may be carried out subsequent to the polymerization reaction by adding the acid catalyst for the cyclization reaction to the polymerization reaction solution where the polymerization reaction has been completed.

The used amount of the hydrocarbon solvent is generally from 5 to 60% by weight, and preferably from 20 to 40% by weight, in terms of the solid content of the conjugated diene polymer.

The cyclization reaction may be carried out under increased pressure, reduced pressure or atmospheric pressure, and is preferably carried out under atmospheric pressure from the standpoint of simpleness of operation. The cyclization reaction may be carried out under a dry gas stream, particularly in an atmosphere of dry nitrogen or dry argon, for suppressing side reactions caused by moisture.

The reaction temperature and the reaction time of the cyclization reaction are not particularly limited. The reaction temperature is generally from 50 to 150° C., and preferably from 70 to 110° C., and the reaction time is generally from 0.5 to 10 hours, and preferably from 2 to 5 hours.

After performing the cyclization reaction, the acid catalyst may be deactivated, the acid catalyst residue may be removed, and the hydrocarbon solvent may be then removed, according to ordinary methods, whereby the cyclized product of a conjugated diene polymer in a solid form can be obtained.

The unsaturated bond reduction rate of the cyclized product of a conjugated diene polymer is generally 10% or more, preferably from 35 to 75%, and more preferably from 40 to 65%. The unsaturated bond reduction rate of the cyclized product of a conjugated diene polymer can be controlled by appropriately selecting the amount of the acid catalyst, the reaction temperature and the reaction time in the cyclization reaction.

In the case where the unsaturated bond reduction rate of the cyclized product of a conjugated diene polymer is too small, the glass transition temperature thereof is decreased, and the adhesion strength is decreased. The cyclized product of a conjugated diene polymer having a too large unsaturated bond reduction rate, on the other hand, is difficult to produce, and only a brittle one can be obtained.

The unsaturated bond reduction rate referred herein is an index expressing the extent of reduction of unsaturated bonds owing to the cyclization reaction in the conjugated diene monomer unit moiety in the conjugated diene polymer, and a value obtained in the following manner. In proton NMR analysis, the ratio of the peak area of protons connected directly to double bonds to the peak area of all protons in the conjugated diene monomer unit moiety in the conjugated diene polymer is obtained before and after the cyclization reaction, and the reduction rate thereof is calculated.

In the conjugated diene monomer unit moiety in the conjugated diene polymer, the peak area of all protons before the cyclization reaction is expressed by SBT, the peak area of protons connected directly to double bonds before the cyclization reaction is expressed by SBU, the peak area of all protons after the cyclization reaction is expressed by SAT, and the peak area of protons connected directly to double bonds after the cyclization reaction is expressed by SAU.

The peak area ratio (SB) of protons connected directly to double bonds before the cyclization reaction is expressed as follows.

SB=SBU/SBT

The peak area ratio (SA) of protons connected directly to double bonds after the cyclization reaction is expressed as follows.

SA=SAU/SAT

Accordingly, the unsaturated bond reduction rate can be obtained by the following expression.

Unsaturated bond reduction rate(%)=100×(SB−SA)/SB

The cyclized product of a conjugated diene polymer generally has a weight average molecular weight of from 1,000 to 1,000,000, preferably from 10,000, to 900,000, and more preferably from 30,000 to 800,000, in terms of standard polystyrene measured by gel permeation chromatography. The weight average molecular weight of the cyclized product of a conjugated diene polymer can be controlled by appropriately selecting the weight average molecular weight of the conjugated diene polymer subjected to the cyclization reaction.

In the case where the weight average molecular weight of the cyclized product of a conjugated diene polymer is too small, there is a possibility that it is difficult to mold, and the mechanical strength thereof is lowered. In the case where the weight average molecular weight of the cyclized product of a conjugated diene polymer is too large, there is a possibility that the viscosity of the solution in the cyclization reaction is increased to impair the handleability, and the processability upon molding is impaired.

The cyclized product of a conjugated diene polymer generally has a gel content (insoluble content in toluene) of 10% by weight or less, and preferably 5% by weight or less, and particularly preferably contains substantially no gel. In the case where the gel content is large, there is a possibility that the processability upon molding is impaired, and it becomes difficult to obtain a smooth film.

In the invention, only one kind of the cyclized product of a conjugated diene polymer may be solely used, and two or more kinds thereof that are different in monomer composition, molecular weight, unsaturated bond reduction rate, gel content and the like may be used in combination.

In the invention, an antioxidant may be added to the cyclized product of a conjugated diene polymer for ensuring stability upon processing the cyclized product of a conjugated diene polymer. The amount of the antioxidant is generally 5,000 ppm or less, preferably 3,000 ppm or less, more preferably from 10 to 2,000 ppm, and particularly preferably from 50 to 1,500 ppm, based on the weight of the cyclized product of a conjugated diene polymer.

It is important to control the addition amount of the antioxidant appropriately in consideration of stability upon processing since the oxygen absorption capability is impaired when the addition amount of the antioxidant is too large.

The antioxidant is not particularly limited as far as it is selected from those ordinarily used in the fields of resin materials and rubber materials. Representative examples of the antioxidant include a hindered phenolic antioxidant, a phosphorous-containing antioxidant and a lactone antioxidant. An amine light stabilizer (HALS) may also be added. The antioxidants may be used in combination of two or more kinds of them. In particular, it is preferred to use a hindered phenolic antioxidant and a phosphorous-containing antioxidant in combination.

Specific examples of the hindered phenolic antioxidant include 2,6-di-t-butyl-p-cresol, pentaerythritol tetrakis(3-(3,5-di-t-butyl-4-hydroxyphenyl)propionate), thiodiethylenebis(3-(3,5-di-t-butyl-4-hydroxyphenyl)propionate), octadecyl-3-(3,5-di-t-butyl-4-hydroxyphenyl)propionate, N,N′-hexane-1,6-diylbis(3-(3,5-di-t-butyl-4-hydroxyphenyl)propionamide), diethyl((3,5-bis(1,1-dimethylethyl)-4-hydroxyphenyl)methyl)phosphonate, 3,3′,3″,5,5′,5″-hexa-t-butyl-a,a′,a″-(mesitylene-2,4,6-triyl)tri-p-cresol, hexamethylenebis(3-(3,5-di-t-butyl)-4-hydroxyphenyl)propionate, tetrakis(methylene-3-(3,5-di-t-butyl-4-hydroxyphenyl)propionate)methane, n-octadecyl-3-(4′-hydroxy-3,5′-di-t-butylphenyl)propionate, 1,3,5-tris(3,5-di-t-butyl-4-hydroxybenzyl)-1,3,5-triazine-2,4,6(1H,3H,5H)-trione, 2,4-bis(n-octylthio)-6-(4-hydroxy-3,5-di-t-butylanilino)-1,3,5-triazine, tris(3,5-di-t-butyl-4-hydroxybenzyl)isocyanurate, 2-t-butyl-6-(3′-t-butyl-2′-hydroxy-5′-methylbenzyl)-4-methylphenyl acrylate, 2-(1-(2-hydroxy-3,5-di-t-butylphenyl)ethyl)-4,6-di-t-pentylphenyl acrylate and the like.

Examples of the phosphorus-containing antioxidant include 2,2′-methylenebis(4,6-di-t-butylphenyl)octylphosphite, tris(2,4-di-t-butylphenyl)phosphite, bis(2,4-bis(1,1-dimethylethyl)-6-methylphenyl)ethyl phosphite, tetrakis(2,4-di-t-butylphenyl)(1,1-biphenyl)-4,4′-diylbisphosphonite, bis(2,4-di-t-butylphenyl)pentaerythritol phosphite and the like.

A lactone antioxidant, which is a reaction product of 5,7-di-t-butyl-3-(3,4-dimethylphenyl)-3H-benzofuran-2-one and o-xylene, may be used in combination.

Examples of the amine light stabilizer (HALS) include bis(2,2,6,6-tetramethyl-4-piperidyl sebacate and the like.

Various kinds of compounds that are ordinarily added may be incorporated with the cyclized product of a conjugated diene polymer, as the need arises. Examples of such compounds include a filler, such as calcium carbonate, alumina and titanium oxide; a tackifier (such as a hydrogenated petroleum resin, a hydrogenated terpene resin, a ricinus derivative, a sorbitan higher fatty acid ester); a plasticizer (such as a phthalate ester and a glycol ester); a softening agent (such as a paraffin oil and polybutene); a surfactant; a leveling agent; an ultraviolet ray absorbent; a light stabilizer; a dehydrating agent; a pot life enhancing agent (such as acetylacetone, methanol and methyl orthoacetate); a repelling improving agent; and the like.

The oxygen absorbent of the invention may contain an oxygen-absorbing component other than the cyclized product of a conjugated diene polymer as far as the advantages of the invention are not impaired. The amount of the oxygen-absorbing component other than the cyclized product of a conjugated diene polymer is less than 50% by weight, preferably less than 40% by weight, and further preferably less than 30% by weight, based on the total amount of the oxygen-absorbing components (i.e., the total amount of the cyclized product of a conjugated diene polymer and the oxygen-absorbing component other than the cyclized product of a conjugated diene polymer).

The form of the oxygen absorbent of the invention is not particularly limited, and may be used in various forms, such as a film form, a pellet form and a powder form. The shapes of the pellets and powder are not limited. Among these, a film form and a powder form are preferred since the surface area per unit weight is increased, and the oxygen-absorbing rate is enhanced.

Strictly speaking, an article having a thickness of 10 μm or more and less than 250 μm is classified into a film, and an article having a thickness of 250 μm or more and less than 3 mm is classified into a sheet. In the invention, however, both the articles are referred to as films as a generic term.

In the oxygen-absorbing film and the oxygen-absorbing multi-layer film of the invention, the total thickness thereof varies depending on the layer structure and the purpose, and is generally from 20 to 7,000 μm, and preferably from 30 to 5,000 μm.

The number average particle diameter of the powder is generally from 1 to 1,000 μm, and preferably from 10 to 500 μm.

The method for shaping the oxygen absorbent of the invention into a desired shape is not particularly limited, and a known method may be used.

The oxygen absorbent in a powder form can be obtained, for example, by pulverizing the oxygen absorbent in an atmosphere at a temperature lower than the glass transition temperature of the cyclized product of a conjugated diene polymer contained in the oxygen absorbent.

The oxygen-absorbing film of the invention comprises the oxygen absorbent of the invention as an effective component.

Though the oxygen-absorbing film of the invention may comprise only the oxygen absorbent of the invention comprising a cyclized product of a conjugated diene polymer having a vinyl bond content in a conjugated diene monomer unit moiety of 4% by mol or less, it is preferred that a polymer material other than the cyclized product of a conjugated diene polymer is incorporated therewith.

According to the constitution, the oxygen-absorbing film of the invention is enhanced in tear strength.

The polymer material other than the cyclized product of a conjugated diene polymer to be used is not particularly limited, and is preferably a thermoplastic resin. Various kinds of rubber may be used in combination with the thermoplastic resin.

The polymer material other than the cyclized product of a conjugated diene polymer may be used solely or in combination of two or more kinds thereof.

In the oxygen absorbent comprising the cyclized product of a conjugated diene polymer and the polymer material other than the cyclized product of a conjugated diene polymer, the content of the cyclized product of a conjugated diene polymer is preferably 10% by weight or more, more preferably from 90 to 20% by weight, further preferably from 85 to 30% by weight, still further preferably from 80 to 40% by weight, and particularly preferably from 80 to 50% by weight. The oxygen-absorbing capability and the tear strength are well balanced within the aforementioned range, and the oxygen-absorbing capability is enhanced when the proportion of the cyclized product of a conjugated diene polymer is larger.

The thermoplastic resin is not particularly limited, and is preferably at least one selected from the group consisting of an olefin resin, a polyester resin, a polyamide resin and a polyvinyl alcohol resin.

Specific examples of the thermoplastic resin include, while not particularly limited, an olefin resin; an aromatic vinyl resin, such as polystyrene; a vinyl halide resin, such as polyvinyl chloride; a polyvinyl alcohol resin, such as polyvinyl alcohol and an ethylene/vinyl alcohol copolymer; a fluororesin; an acrylate resin, such as a methacrylate resin; a polyamide resin, such as nylon 6, nylon 66, nylon 610, nylon 11, nylon 12, MXD nylon and copolymers thereof; a polyester resin, such as polyethylene terephthalate, polyethylene terephthalate having cyclohexanedimethanol copolymerized therewith, and polybutylene terephthalate; a polycarbonate resin; a polyurethane resin; and the like. Among these, an olefin resin and a polyvinyl alcohol resin are preferred.

The olefin resin may be either a homopolymer of an α-olefin, a copolymer of two or more kinds of α-olefins, or a copolymer of an α-olefin with a monomer other than an α-olefin, and may be a product obtained by modifying these (co)polymers.

Specific examples of the olefin resin include a homopolymer or a copolymer of an α-olefin, such as ethylene and propylene, for example, a homopolymer of an α-olefin, such as polyethylene, e.g., linear low-density polyethylene (LLDPE), low-density polyethylene (LDPE), medium-density polyethylene (MDPE), high-density polyethylene (HDPE) and metallocene polyethylene, polypropylene, metallocene polypropylene, polymethylpentene and polybutene; a copolymer of ethylene with an α-olefin, such as an ethylene/propylene random copolymer, an ethylene/propylene block copolymer, an ethylene/propylene/polybutene-1 copolymer and an ethylene/cyclic olefin copolymer; a copolymer of an α-olefin with an unsaturated alcohol carboxylate with the α-olefin as the major component, and a saponified product thereof, such as an ethylene/vinyl acetate copolymer and an ethylene/vinyl alcohol copolymer; a copolymer of an α-olefin with an α,β-unsaturated carboxylate ester, an α,β-unsaturated carboxylic acid or the like with the α-olefin as the major component, such as an ethylene/α,β-unsaturated carboxylate ester copolymer (e.g., an ethylene/ethyl acrylate copolymer and an ethylene/methyl methacrylate copolymer), and an ethylene/α,β-unsaturated carboxylic acid copolymer (e.g., an ethylene/acrylic acid copolymer and an ethylene/methacrylic acid copolymer); an acid-modified olefin resin obtained by modifying an α-olefin (co)polymer, such as polyethylene and polypropylene, with an unsaturated carboxylic acid and/or an anhydride thereof, such as acrylic acid, methacrylic acid, maleic acid, maleic anhydride, fumaric acid and itaconic acid; an ionomer resin obtained by causing a Na ion, a Zn ion or the like to act on an ethylene/methacrylic acid copolymer or the like; mixtures thereof; and the like.

Among these resins, polyethylene, polypropylene and random and block ethylene/propylene copolymers are preferred.

Examples of rubbers that can be used in combination with the thermoplastic resin include natural rubber, polybutadiene rubber, polyisoprene rubber, poly(acrylonitrile/butadiene) rubber, poly(styrene/butadiene) rubber, poly(styrene/isoprene) block copolymer rubber, poly(ethylene/propylene/diene) rubber, acrylic rubber and the like.

Using the oxygen absorbent of the invention according to an arbitrary method can produce the oxygen-absorbing film of the invention. Specifically, for example, it can be molded by a solution casting method or by extrusion molding through a die having a prescribed shape, such as a T-die and a circular die, by using a uniaxial or multiaxial melt extruder. It can also be shaped into a desired shape by using a compression molding method, a blow molding method, an injection molding method, a vacuum forming method, a pressure forming method, an offset molding method, a plug-assist molding method or a powder molding method.

The multi-layer film of the invention comprises the oxygen-absorbing film of the invention as an essential constitutional layer.

In the multi-layer film of the invention, a film layer constituting the multi-layer film along with the oxygen-absorbing film layer of the invention can be appropriately selected depending on purposes, and specific examples thereof include a sealing material layer, a gas barrier material layer, a deodorizing agent layer and a protective material layer.

In the oxygen-absorbing multi-layer film of the invention, the oxygen-absorbing film layer, the sealing material layer, the gas barrier material layer, the deodorizing agent layer and the protective material layer each may be constituted of a single layer or a plurality of layers, and in the case of a plurality of layers, the layers may be the same as or different from each other.

The thickness of these layers may be appropriately selected depending on purposes.

In the oxygen-absorbing multi-layer film of the invention, the thickness of the oxygen-absorbing film layer is not particularly limited, and is generally from 3 to 100 μm, and preferably from 5 to 80 μm. In the case where the thickness of the oxygen-absorbing film layer is within the range, favorable oxygen absorption capability can be exhibited, and it is preferred from the standpoint of economy and properties of the container, such as flexibility and ductility of the material.

In the multi-layer film, the order of lamination of the layers is not particularly limited, and in the case where a packaging container is constituted, an order of the sealing material layer, the oxygen-absorbing film layer, the gas barrier material layer and the protective material layer is preferred.

A deodorizing agent layer may not be provided since the oxygen-absorbing film using the oxygen absorbent of the invention does not generate an unpleasant odor component upon absorbing oxygen, and may be appropriately used depending on an article housed in the packaging container.

The sealing material layer has such a function in that the layer is melted under heat to be adhered to each other (heat-sealed), whereby a space shielded from the exterior is formed inside a packaging container formed of the oxygen-absorbing multi-layer film, and is such a layer that prevents the oxygen-absorbing film layer from being in contact with an article to be packed inside the packaging container, and simultaneously makes oxygen permeate therethrough and be absorbed by the oxygen-absorbing film layer.

Specific examples of a heat sealable resin used for forming the sealing material layer include a homopolymer of an α-olefin, e.g., ethylene and propylene, such as low-density polyethylene, medium-density polyethylene, high-density polyethylene, linear low-density polyethylene, metallocene polyethylene, polypropylene, polymethylpentene and polybutene; a copolymer of ethylene with an α-olefin, such as an ethylene/propylene copolymer; a copolymer of an α-olefin with vinyl acetate, an acrylate ester, a methacrylate ester or the like with the α-olefin as the major component, such as an ethylene/vinyl acetate copolymer, an ethylene/ethyl acrylate copolymer, an ethylene/methyl methacrylate copolymer, an ethylene/acrylic acid copolymer and an ethylene/methacrylic acid copolymer; an acid-modified olefin resin obtained by modifying an olefin resin, such as polyethylene and polypropylene, with an unsaturated carboxylic acid, such as acrylic acid, methacrylic acid, maleic acid, maleic anhydride, fumaric acid and itaconic acid; an ionomer resin obtained by causing a Na ion, a Zn ion or the like to act on an ethylene/methacrylic acid copolymer; mixtures thereof; and the like.

With the resin used as the sealing material layer, there may be incorporated a heat stabilizer; an ultraviolet ray absorbent; an antioxidant; a coloring agent; a pigment; a neutralizing agent; a plasticizer, such as a phthalate ester and a glycol ester; a filler; a surfactant; a leveling agent; a light stabilizer; a dehydrating agent, such as an alkaline earth metal oxide; a deodorizing agent, such as activated carbon and zeolite; a tackifier (such as a ricinus derivative, a sorbitan higher fatty acid ester and low-molecular weight polybutene); a pot life enhancing agent (such as acetylacetone, methanol and methyl orthoacetate); a repelling improving agent; other resins (such as poly-α-olefin), and the like.

A blocking preventing agent, an antifoggant, a heat resistant stabilizer, a weather resistant stabilizer, a lubricant, an antistatic agent, a reinforcing agent, a flame retardant, a coupling agent, a foaming agent, a releasing agent and the like may be added as the need arises.

The gas barrier material layer may be provided on either side of the oxygen-absorbing layer of the oxygen-absorbing multi-layer film, and from the standpoint of absorption of oxygen inside the container, however, it is preferably provided on such a side that constitutes the outer surface of the packaging container upon forming the packaging container with the oxygen-absorbing multi-layer film.

The material constituting the gas barrier material layer is not particularly limited as far as it has low permeability to a gas, such as oxygen and water vapor, and a metal, an inorganic material, a resin and the like are used.

The metal may generally be aluminum having low gas permeability. The metal may be a foil laminated on a resin film or the like, or may be a thin film vapor-deposited on a resin film or the like.

The inorganic material may be a metallic oxide, such as silica and alumina, and the metallic oxide is used solely or in combination of two or more kinds thereof and vapor-deposited on a resin film or the like.

The resin is inferior in gas barrier capability to a metal and the inorganic material but has extensive options in mechanical properties, thermal properties, chemical resistance, optical properties and production methods, and therefore, it is preferably used as the gas barrier material based on these advantages. The resin used in the gas barrier material layer is not particularly limited, and any resin that has good gas barrier capability may be used. A resin containing no chlorine is preferably used since a toxic gas is not generated upon incineration.

Among these, a transparent vapor deposition film obtained by vapor-depositing an inorganic oxide on a resin film is preferably used.

Specific examples of the resin used in the gas barrier material layer include a polyvinyl alcohol resin, such as polyvinyl alcohol and an ethylene/polyvinyl alcohol copolymer; a polyester resin, such as polyethylene terephthalate and polybutylene terephthalate; a polyamide resin, such as nylon 6, nylon 66, nylon 610, nylon 11, nylon 12, MXD nylon (poly-m-xyleneadipamide) and copolymers thereof; a polyaramid resin; a polycarbonate resin; a polystyrene resin; a polyacetal resin; a fluororesin; thermoplastic polyurethane, such as a polyether series, an adipate ester series, a caprolactone ester series and a polycarbonate ester series; a vinyl halide resin, such as polyvinylidene chloride and polyvinyl chloride; polyacrylonitrile; a copolymer of an α-olefin and vinyl acetate, an acrylate ester, a methacrylate ester or the like, such as an ethylene/vinyl acetate copolymer, an ethylene/ethyl acrylate copolymer, an ethylene/methyl methacrylate copolymer, an ethylene/acrylic acid copolymer and an ethylene/methacrylic acid copolymer; an acid-modified olefin resin obtained by modifying an α-olefin (co)polymer, such as polyethylene and polypropylene, with an unsaturated carboxylic acid, such as acrylic acid, methacrylic acid, maleic acid, maleic anhydride, fumaric acid and itaconic acid; an ionomer resin obtained by causing a Na ion, a Zn ion or the like to act on an ethylene/methacrylic acid copolymer or the like; mixtures thereof; and the like. The gas barrier material layer may have an inorganic oxide, such as aluminum oxide and silicon oxide, vapor-deposited thereon.

These resins may be appropriately selected depending on purpose of the multi-layer film in consideration of demanded characteristics including gas barrier capability, mechanical properties, such as strength, ductility and rigidity, heat resistance, printing property, transparency and adhesion property. These resins may be used solely or in combination of two or more kinds of them.

Among these, an ethylene/vinyl alcohol copolymer is preferred since it can be melt-molded and has good gas barrier capability under high humidity.

The resin used in the gas barrier material layer may contain various compounds as similar to those added to the sealing material layer.

In the case where a protective material layer is provided in the oxygen-absorbing multi-layer film of the invention for such purpose as provision of heat resistance, it is preferably provided on the outer side of the gas barrier material layer, i.e., on the outer side when the container is constituted from the oxygen-absorbing multi-layer film.

Examples of the resin used in the protective material layer include an ethylene polymer, such as high-density polyethylene; a propylene polymer, such as a propylene homopolymer, a propylene/ethylene random copolymer and a propylene/ethylene block copolymer; polyamide, such as nylon 6 and nylon 66; polyester, such as polyethylene terephthalate; and the like. Among these, polyamide and polyester are preferred.

In the case where a polyester film, a polyamide film, an inorganic oxide vapor-deposited film, a vinylidene chloride-coated film, or the like is used as the gas barrier material layer, the gas barrier material layer also functions as the protective material layer simultaneously.

The oxygen-absorbing multi-layer film of the invention may have a supporting substrate layer as the need arises.

Examples of a material constituting the supporting substrate layer include an olefin resin; a polyester resin, such as polyethylene terephthalate (PET); a polyamide resin, such as nylon 6 and a nylon 6/nylon 66 copolymer; natural fibers; synthetic fibers; and paper manufactured with these fibers.

The supporting substrate layer is preferably provided on the outer side of the oxygen-absorbing film layer upon constituting the packaging container with the oxygen-absorbing multi-layer film of the invention.

In the oxygen-absorbing multi-layer film of the invention, an adhesive layer comprising an adhesive resin may be provided between the oxygen-absorbing film layer and the layer provided as the need arises, such as the deodorizing agent layer, the gas barrier material layer, the sealing material layer and the protective material layer. The adhesive layer may be a film or a sheet of a resin that can be fused and adhered to each other under heat. Specific examples of the resin include a homopolymer or a copolymer of an α-olefin, such as low-density polyethylene, linear low-density polyethylene, medium-density polyethylene, high-density polyethylene and polypropylene; an ethylene/vinyl acetate copolymer, an ethylene/acrylic acid copolymer, an ethylene/ethyl acrylate copolymer, an ethylene/methacrylic acid copolymer and an ethylene/methyl methacrylate copolymer; an acid-modified olefin resin obtained by modifying an α-olefin (co)polymer, such as polyethylene and polypropylene, with an unsaturated carboxylic acid and/or an anhydride thereof, such as acrylic acid, methacrylic acid, maleic acid and maleic anhydride; an ionomer resin obtained by causing a Na ion, a Zn ion or the like to act on an ethylene/methacrylic acid copolymer or the like; mixtures thereof; and the like.

The shape of the oxygen-absorbing multi-layer film of the invention is not particularly limited, and may be a flat film, a seamless tube and the like.

The oxygen-absorbing multi-layer film of the invention can be obtained by melting and co-extruding the cyclized product of a conjugated diene polymer, the resins and the like constituting the respective layers from an extruder according to a known co-extruding method (such as a water-cooled or air-cooled inflation method and a T-die extruding method (T-die molding method)). In the water-cooled inflation method, for example, the resins are melted under heat in several extruding machines and extruded from a multi-layer annular die, followed by quenched for solidification with a liquid refrigerant, such as cooling water, whereby a tubular stock material.

The extruding machine may be a uniaxial extruder or a multiaxial extruder, which have been known.

Upon producing the oxygen-absorbing multi-layer film of the invention, the temperature of the cyclized product of a conjugated diene polymer and the resins for the layers is preferably from 160 to 250° C. In the case where the temperature is lower than 160° C., unevenness in thickness and breakage of the multi-layer film may occur, and in the case where it exceeds 250° C., breakage of the multi-layer film may occur. It is more preferably from to 230° C.

The winding speed of the oxygen-absorbing multi-layer film upon producing the multi-layer film is generally from 2 to 200 m/min, and preferably from 50 to m/min. In the case where winding speed is too small, there is a possibility that the production efficiency is deteriorated, and in the case where it is too large, there are some cases where the multi-layer film cannot be sufficiently cooled, which results in fusion upon winding.

An extrusion coating method and a sandwich lamination method may be employed for producing the oxygen-absorbing multi-layer film of the invention. Films for the respective layers, which have been produced in advance, may be formed into the multi-layer film by dry lamination.

In the case where the oxygen-absorbing multi-layer film comprises a material capable of being stretched, and the film properties can be enhanced by stretching, as similar to a polyamide resin, a polyester resin, polypropylene and the like, the oxygen-absorbing multi-layer film obtained by co-extrusion may be uniaxially or biaxially stretched. It may be further heat-set as the need arises.

The stretching ratio is not particularly limited, and is preferably from 1 to 5 times for the machine direction (MD) and the transversal direction (TD), respectively, and preferably from 2.5 to 4.5 times for the machine and transversal directions, respectively.

The stretching operation may be carried out by a known method, such as a tenter stretching method, an inflation stretching method and a roll stretching method. The stretching operation may be carried out at first in either the machine or transversal direction, and is preferably carried out in the machine and transversal directions simultaneously. A tubular simultaneous biaxially stretching method may be employed.

A desired printing pattern, such as a letter, a figure, a symbol, a picture and a pattern, may be printed as front-surface printing or back-surface printing on the outer side of the oxygen-absorbing multi-layer film of the invention by a known printing method.

The oxygen-absorbing multi-layer film of the invention may be formed into a packaging material.

A packaging container can be formed with the oxygen-absorbing multi-layer film of the invention. Examples of the form of the packaging container include a casing, a pouch, a pouch with a gazette, a standing pouch and a bag, such as a pillowcase bag.

The packaging container obtained by molding the oxygen-absorbing multi-layer film of the invention can be favorably used for charging and packaging of a beverage, such as beer, wine, fruit juice, a carbonated non-alcohol beverage, oolong tea and green tea; various kinds of foods, such as fruits, nuts, vegetables, meats, infant foods, coffee, jam, mayonnaise, ketchup, edible oil, dressing, sauce, soy sauce-boiled foods and dairy foods; other foods (such as box lunch, prepared foods, rice cakes and ramen noodles); chemicals, such as an adhesive and a pressure-sensitive adhesive; cosmetics; pharmaceuticals; miscellaneous goods, such as a chemical warmer; other articles; and the like. In particular, the packaging container of the invention is suitable for such purposes as packaging of foods since it is free of odor problems.

### Examples

The invention will be described in more detail with reference to production examples, examples and comparative examples below. All “part” and “%” in the examples are by mass unless otherwise indicated.

The characteristics were evaluated in the following manners.

### (Weight Average Molecular Weight (Mw) of Cyclized Product of Conjugated Diene Polymer)

It is obtained as a molecular weight in terms of polystyrene by using gel permeation chromatography.

### (Vinyl Bond Content)

It is obtained by ¹H-NMR measurement.

### (Unsaturated Bond Reduction Rate of Cyclized Product of Conjugated Diene Polymer)

It is obtained by proton NMR measurement by referring to the methods disclosed in the literatures (i) and (ii) below.
(i) M. A. Golub and J. Heller, Can. J. Chem., vol. 41, p. 937 (1963)
(ii) Y. Tanaka and H. Sato, J. Polym. Sci., Poly. Chem. Ed., vol. 17, p. 3027 (1979)

In the conjugated diene monomer unit moiety in the conjugated diene polymer, the peak area of all protons before the cyclization reaction is expressed by SBT, the peak area of protons connected directly to double bonds before the cyclization reaction is expressed by SBU, the peak area of all protons after the cyclization reaction is expressed by SAT, and the peak area of protons connected directly to double bonds after the cyclization reaction is expressed by SAU.

The peak area ratio (SB) of protons connected directly to double bonds before the cyclization reaction is expressed as follows.

SB=SBU/SBT

The peak area ratio (SA) of protons connected directly to double bonds after the cyclization reaction is expressed as follows.

SA=SAU/SAT

Accordingly, the unsaturated bond reduction rate can be obtained by the following expression.

Unsaturated bond reduction rate(%)=100×(SB−SA)/SB

### (Aldehyde Odor)

An oxygen-absorbing multi-layer film is cut into a size of 100 mm×100 mm and placed in an aluminum pouch (Aluminum Hiretort ALH-9, a trade name, produced by Sakura Bussan Co., Ltd.) having a size of 300 mm×400 mm. After completely removing the air inside, 200 cc of air is newly charged. The pouch is allowed to stand at 25° C., and the oxygen concentration inside the pouch is measured by using an oxygen concentration meter (Food Checker HS-750, a trade name, produced by CeramTec U.S.). The oxygen-absorbed amount (unit: cc per 100 cm²) per 100 cm² (in terms of surface area) of the oxygen absorbent in a film form is obtained from the result. At the time where the oxygen-absorbed amount is about 10 cc per 100 cm² and the time where it is 20 cc per 100 cm², the aldehyde concentration (unit: ppm) inside the pouch is measured with an aldehyde detector tube No. 92 or No. 92L (produced by Gastec Corp.), which is designated as aldehyde odor (unit: ppm).

The same test is carried out with the temperature when the pouch is allowed to stand being 60° C.

The oxygen concentration of the air before absorption oxygen is 20.7%.

### Example 1

### Production of Cyclized Product of Conjugated Diene Polymer AK and Pellets Thereof

300 parts of polyisoprene (polyisoprene polymerized with a Ziegler catalyst, cis-1,4-bond unit: 97%, trans-1,4-bond unit: 2%, 3,4-bond unit: 1%, 1,2-bond unit: not detected, weight average molecular weight: 1,160,000) cut into 10 mm squares was charged along with 10,000 parts of cyclohexane in a pressure-resistant reactor equipped with a stirrer, a thermometer, a reflux condenser and a nitrogen gas introducing tube, and the interior of the reactor was purged with nitrogen. The contents were heated to 75° C., and polyisoprene was completely dissolved in cyclohexane under stirring. p-Toluenesulfonic acid having a water content of 150 ppm or less in an amount of 15 parts was then added as a 15% toluene solution thereto, and a cyclization reaction was carried out while the inner temperature was controlled not to exceed 80° C. After continuing the reaction for 2 hours, 23.12 parts of a 25% sodium carbonate aqueous solution was added thereto to terminate the reaction. After removing water by azeotropic reflux dehydration at 80° C., the catalyst residue in the system was removed by using a glass fiber filter having a pore size of 2 μm, whereby a (cyclohexane/toluene) solution of cyclized polyisoprene AK having an unsaturated bond reduction rate of 49.6% and a weight average molecular weight of 719,000 was obtained.

To the resultant solution of cyclized polyisoprene AK, an amount corresponding to 200 ppm based on the cyclized polyisoprene of a hindered phenolic antioxidant, octadecyl-3-(3,5-di-t-butyl-4-hydroxyphenyl)propionate (Irganox 1076, a trade name, produced by Ciba Specialty Chemicals Inc.), an amount corresponding to 400 ppm of a phosphorous-containing antioxidant, 2,2′-methylenebis(4,6-di-t-butylphenyl)octylphosphite (Adeka Stab HP-10, a trade name, produced by Adeka Corp.), and polyethylene pellets (Moretec 0438, a trade name, produced by Idemitsu Petrochemical Co., Ltd.) having a melt flow rate of 4.0 g per 10 minutes (190° C., load: 2.16 kg) were added. Cyclohexane in the solution was then removed, and toluene was removed by vacuum drying, whereby a cyclized polyisoprene AK/polyethylene blend in a solid form was obtained.

The resultant cyclized polyisoprene AK/polyethylene blend was formed into pellets by kneading with a uniaxial kneading extruder (Ikegai Uniaxial Kneading Extruder produced by Ikegai Ltd. (diameter: 40 mm, L/D: 25, diameter of die: 3 mm, one opening)) under the kneading conditions of a temperature of cylinder 1 of 140° C., a temperature of cylinder 2 of 150° C., a temperature of cylinder 3 of 160° C., a temperature of cylinder 4 of 170° C., a temperature of die of 170° C. and a revolution number of 25 rpm, whereby pellets ak/e of the cyclized polyisoprene AK/polyethylene blend were obtained.

### Example 2

### Production of Cyclized Product of Conjugated Diene Polymer BK and Pellets Thereof

Cyclized polyisoprene BK having an unsaturated bond reduction rate of 45.2% and a weight average molecular weight of 736,000 was obtained in the same manner as in Production Example 1 except that the amount of p-toluenesulfonic acid as a cyclization catalyst was 9 parts, and that the amount of the 25% sodium carbonate solution was 13.88 parts.

Pellets bk/e of the cyclized polyisoprene BK/polyethylene blend were obtained in the same manner as in Production Example 1 by using the cyclized polyisoprene BK instead of the cyclized polyisoprene AK.

### Comparative Example 1

### Production of Cyclized Product of Conjugated Diene Polymer CK and Pellets Thereof

Cyclized polyisoprene CK having an unsaturated bond reduction rate of 50.0% and a weight average molecular weight of 139,000 was obtained in the same manner as in Production Example 1 except that polyisoprene polymerized with a lithium catalyst (cis-1,4-bond unit: 73%, trans-1,4-bond unit: 20%, 3,4-bond unit: 7%, 1,2-bond unit: not detected, weight average molecular weight: 154,000) was used instead of the polyisoprene polymerized with a Ziegler catalyst, that the amount of cyclohexane was 700 parts, that the amount of p-toluenesulfonic acid as a cyclization catalyst was 2.19 parts, that the amount of the 25% sodium carbonate solution was 3.36 parts, and that the cyclization reaction temperature was 80° C.

Pellets ck/e of the cyclized polyisoprene CK/polyethylene blend were obtained in the same manner as in Production Example 1 by using the cyclized polyisoprene CK instead of the cyclized polyisoprene AK.

### Example 3

An oxygen-absorbing film akf having a width of 100 mm and a thickness of 20 μm was obtained from the pellets ak/e of the cyclized polyisoprene AK/polyethylene blend obtained in Example 1 by using a T-die extruder and Labo Plastomill equipped with a biaxial stretching tester (both produced by Toyo Seiki Seisaku-sho, Ltd.).

The oxygen-absorbing film was measured for aldehyde odor (aldehyde concentration (unit: ppm)). The results are shown in Table 1.

### Example 4 and Comparative Example 2

Oxygen-absorbing films bkf and ckf having a width of 100 mm and a thickness of 20 μm were obtained in the same manner as in Example 3 except that the pellets bk/e of the cyclized polyisoprene BK/polyethylene blend obtained in Example 2 and the pellets ck/e of the cyclized polyisoprene CK/polyethylene blend are used respectively instead of the pellets ak/e of the cyclized polyisoprene AK/polyethylene blend.

The oxygen-absorbing films were measured for aldehyde odor (aldehyde concentration (unit: ppm)). The results are shown in Table 1.

TABLE 1

| | | | | | Comparative |
|---|---|---|---|---|---|
| | | Example | | | Example |
| | | 3 | 4 | 7 | 2 |
| Oxygen-absorbing film | | akf | bkf | dkf | ckf |
| | vinyl bond content (% by mol) | 1 | 1 | 0 | 7 |
| Aldehyde odor (ppm) | | | | | |
| | Film storage temperature: 25° C. | | | | |

| | | | | |
|---|---|---|---|---|
| At oxygen absorption amount of about 10 cc per 100 cm² | 0 | 0 | 0 | 11 |
| At oxygen absorption amount of about 20 cc per 100 cm² | 1 | 1 | — | 18 |

Film storage temperature: 60° C.

| | | | | |
|---|---|---|---|---|
| At oxygen absorption amount of about 10 cc per 100 cm² | 0 | 0 | 0 | 13 |
| At oxygen absorption amount of about 20 cc per 100 cm² | 2 | 2 | — | 19 |

### Example 5

The oxygen-absorbing film akf comprising the cyclized polyisoprene AK/polyethylene blend obtained in Example 3, a film having a thickness of 30 μm formed from unstretched polypropylene (melt flow rate: 6.9 g per 10 minutes, F-734NP, a trade name, produced by Idemitsu Petrochemical Co., Ltd.), and a film (gas barrier material) having a thickness of 30 μm formed from an ethylene/vinyl alcohol copolymer (melt flow rate: 5.5 g per 10 minutes, Eval E105, a trade name, produced by Kuraray Co., Ltd.) were laminated in this order and adhered by using a hot laminator (EXCELAM II 355Q, a trade name, produced by Gmp Co., Ltd.) set at 150° C., whereby an oxygen-absorbing multi-layer film AKF was obtained.

The oxygen-absorbing multi-layer film AKF was heat-sealed at two positions for providing a pouch having a dimension of 200 mm×100 mm, and 200 cc of air was charged and sealed therein.

The oxygen-absorbing multi-layer film was measured for aldehyde odor (aldehyde concentration (unit: ppm)) The results are shown in Table 2.

### Comparative Example 3

An oxygen-absorbing multi-layer film CKF was obtained in the same manner as in Example 5 except that the oxygen-absorbing film ckf comprising the cyclized polyisoprene CK/polyethylene blend was used instead of the oxygen-absorbing film akf comprising the cyclized polyisoprene AK/polyethylene blend.

The oxygen-absorbing multi-layer film CKF was heat-sealed at two positions for providing a pouch having a dimension of 200 mm×100 mm, and 200 cc of air was charged and sealed therein.

The oxygen-absorbing multi-layer film was measured for aldehyde odor (aldehyde concentration (unit: ppm)). The results are shown in Table 2.

TABLE 2

| | | | | Comparative | |
|---|---|---|---|---|---|
| | | Example 5 | | Example 3 | |
| Oxygen-absorbing multi-layer film | | AKF | | CKF | |
| | vinyl bond content (% by mol) | 1 | | 7 | |
| Film storage temperature | | 25° C. | 60° C. | 25° C. | 60° C. |
| Aldehyde odor (ppm) | | | | | |
| | At oxygen absorption amount of about 10 cc per 100 cm² | 0 | 0 | 11 | 12 |
| | At oxygen absorption amount of about 20 cc per 100 cm² | 1 | 1 | 17 | 21 |

### Example 6

### Production of Cyclized Product of Conjugated Diene Polymer DK and Pellets Thereof

300 parts of polyisoprene polymerized with a lithium catalyst (cis-1,4-bond unit: 73 mol %, trans-1,4-bond unit: 20 mol %, 3,4-bond unit: 7 mol %, 1,2-bond unit: not detected, weight average molecular weight: 154,000) cut into 10 mm squares was charged along with 10,000 parts of cyclohexane in a pressure-resistant reactor equipped with a stirrer, a thermometer, a reflux condenser and a nitrogen gas introducing tube, and the interior of the reactor was purged with nitrogen. The contents were heated to 75° C., and polyisoprene was completely dissolved in cyclohexane under stirring. The entire amount of a solution obtained by dissolving 2.6 mmol of nickel(II) acetylacetonate and 10.4 mmol of triisobutylaluminum in 10 mL of cyclohexane was added thereto, and a hydrogenation reaction was carried out at a hydrogen pressure of 10 kgf/cm² at 75° C. for 2 hours. After completion of the hydrogenation reaction, the hydrogenation reaction solution was poured into 8 L of methanol, and the deposited resin was filtered and dried by allowing it to stand at 0.1 Torr or less and 70° C. for 48 hours, whereby about 300 g of a partially hydrogenated product was obtained. The hydrogenated product had a hydrogenation rate (obtained by ¹H-NMR measurement) of 13.5%, and a 3,4-bond unit and a 1,2-bond unit were not detected.

300 g of the hydrogenated product was charged along with 10,000 parts of cyclohexane in a reactor, and the interior of the reactor was purged with nitrogen. The contents were heated to 75° C., and the hydrogenated product was completely dissolved in cyclohexane under stirring. 15 parts of p-toluenesulfonic acid having a water content of 150 ppm or less was then added as a 15% toluene solution thereto, and a cyclization reaction was carried out while the inner temperature was controlled not to exceed 80° C. After continuing the reaction for 4 hours, 23.12 parts of a 25% sodium carbonate aqueous solution was added thereto to terminate the reaction. After removing water by azeotropic reflux dehydration at 80° C., the catalyst residue in the system was removed by using a glass fiber filter having a pore size of 2 μm, whereby a (cyclohexane/toluene) solution of cyclized product of a conjugated diene polymer DK having an unsaturated bond reduction rate of 64.4% and a weight average molecular weight of 123,000 was obtained.

To the resultant solution, an amount corresponding to 200 ppm based on the cyclized product of a conjugated diene polymer DK of a hindered phenolic antioxidant, octadecyl-3-(3,5-di-t-butyl-4-hydroxyphenyl)propionate (Irganox 1076, a trade name, produced by Ciba Specialty Chemicals Inc.), an amount corresponding to 400 ppm of a phosphorous-containing antioxidant, 2,2′-methylenebis(4,6-di-t-butylphenyl)octylphosphite (Adeka Stab HP-10, a trade name, produced by Adeka Corp.), and polyethylene pellets (Moretec 0438, a trade name, produced by Idemitsu Petrochemical Co., Ltd.) having a melt flow rate of 4.0 g per 10 minutes (190° C., load: 2.16 kg) were added. Cyclohexane in the solution was then removed, and toluene was removed by vacuum drying, whereby pellets dk/e of a cyclized product of conjugated diene polymer DK/polyethylene blend in a solid form were obtained.

### Example 7

An oxygen-absorbing film dkf having a width of 100 mm and a thickness of 20 μm was obtained in the same manner as in Example 3 except that the pellets dk/e of the cyclized polyisoprene DK/polyethylene blend obtained in Example 6 was used instead of the pellets ak/e of the cyclized polyisoprene AK/polyethylene blend.

The oxygen-absorbing film was measured for aldehyde odor (aldehyde concentration (unit: ppm)). The results are shown in Table 1.

It is understood from the result shown in Table 1 that the oxygen-absorbing films using the oxygen absorbent comprising the cyclized product of a conjugated diene polymer having a vinyl bond content within the particular range of the invention are small in aldehyde odor at 25° C. and 60° C. and an oxygen absorption amounts of about 10 cc per 100 cm² and about 20 cc per 100 cm² (Examples 3, 4 and 7).

On the other hand, it is also understood that the oxygen-absorbing film using the oxygen absorbent comprising the cyclized product of a conjugated diene polymer having a vinyl bond content that is larger than the range defined in the invention is large in aldehyde odor at 25° C. and 60° C. and an oxygen absorption amounts of about 10 cc per 100 cm² and about 20 cc per 100 cm² (Comparative Example 2).

Similarly, it is understood from the results shown in Table 2 that the oxygen-absorbing multi-layer film using the oxygen absorbent comprising the cyclized product of a conjugated diene polymer having vinyl bond content within the particular range of the invention is small in aldehyde odor at 25° C. and 60° C. and oxygen absorption amounts of about 10 cc per 100 cm² and about 20 cc per 100 (Example 5).

On the other hand, it is also understood that the oxygen-absorbing multi-layer film using the oxygen absorbent comprising the cyclized product of a conjugated diene polymer having a vinyl bond content that is larger than the range defined in the invention is large in aldehyde odor at 25° C. and 60° C. and an oxygen absorption amounts of about 10 cc per 100 cm² and about 20 cc per 100 cm² (Comparative Example 3).

1. An oxygen absorbent comprising a cyclized product of a conjugated diene polymer having a vinyl bond content in a conjugated diene monomer unit moiety of 4% by mol or less.

2. The oxygen absorbent according to claim 1, wherein the vinyl bond content in a conjugated diene monomer unit moiety constituting the conjugated diene polymer of 2% by mol or less.

3. The oxygen absorbent according to claim 1 or 2, wherein the cyclized product of a conjugated diene polymer has a weight average molecular weight of from 10,000 to 900,000 and an unsaturated bond reduction rate of from 35 to 75%.

4. An oxygen-absorbing film comprising a cyclized product of a conjugated diene polymer having a vinyl bond content in a conjugated diene monomer unit moiety of 4% by mol or less, as an effective component.

5. The oxygen-absorbing film according to claim 4, wherein the vinyl bond content in a conjugated diene monomer unit moiety constituting the conjugated diene polymer of 2% by mol or less.

6. The oxygen-absorbing film according to claim 4 or 5, wherein the oxygen-absorbing film further comprises a thermoplastic resin.

7. The oxygen-absorbing film according to claim 6, wherein the thermoplastic resin is a polyolefin resin.

8. An oxygen-absorbing multi-layer film comprising the oxygen-absorbing film according to claim 4 as an essential constitutional layer.

9. A packaging material comprising the oxygen-absorbing multi-layer film according to claim 8.

10. A packaging container obtained by molding the oxygen-absorbing multi-layer film according to claim 8.
